(19) United States
(12) Patent Application Publication
(10) Pub. No.: US 2012/0180469 A1
(43) Pub. Date: Jul. 19, 2012

(54) HEAVY DOOR ASSIST SYSTEM

(75) Inventors: Robert Knepple, Kalamazoo, MI (US); Andrew Bishop, Allegan, MI (US); David Lego, Wadsworth, OH (US); Dominic Number, Orrville, OH (US); Paxton Augustine, Kalamazo, MI (US)

(73) Assignee: PARKER HANNIFIN CORPORATION, Cleveland, OH (US)

(21) Appl. No.: 13/498,158

(22) PCT Filed: Oct. 6, 2010
(86) PCT No.: PCT/US10/51566

§ 371 Date: Mar. 26, 2012

Related U.S. Application Data
(60) Provisional application No. 61/248,978, filed on Oct. 6, 2009.

(51) Int. Cl. F15B 15/02

(52) U.S. Cl. 60/407

(57) ABSTRACT

A heavy door open and close system is provided using a pneumatic cylinder utilizing on board vehicle air. The system includes a hydraulic cylinder which is adapted to lock the door in either an open or closed position. A manual activation system uses a hydraulic valve to unlock the hydraulic cylinder and a pneumatic valve to actuate the pneumatic cylinder to open or close the door. An emergency pneumatic actuation system is also provided for use when the system loses the use of on board air of the vehicle.

### CROSS-REFERENCE TO RELATED CASES

This application is a National Stage application of PCT Application No. PCT/US2010/051566, filed Oct. 6, 2010, to which this application claims priority and the benefit of U.S. Provisional Application No. 61/248,978; filed Oct. 6, 2009, the disclosure of which is also hereby incorporated by reference.

### TECHNICAL FIELD

The present invention relates generally to a system for pneumatically opening and closing heavy doors and locking the door in position with a hydraulic lock mechanism.

### BACKGROUND OF THE INVENTION

The properties of pneumatic cylinders make them particularly useful in an application where a heavy door or hatch needs to be opened or closed such as with the armored doors of military vehicles. These doors must be able to be held in position against a high opposing force that might be greater that the ability of the compressed air of the pneumatic cylinders to resist. Another problem associated with the use of compressed air in door opening application is that the high force and speed of the pneumatic cylinder may be too fast and may damage the heavy door and door linkage.

### SUMMARY

At least one embodiment of the invention provides a door actuation system for a vehicle comprising: a pneumatic cylinder connected by a valve to a source of on-board compressed air; a hydraulic cylinder having a hydraulic valve that when open allows hydraulic fluid to move from one of a first and second side of the hydraulic cylinder to the other of the first and second side of the hydraulic cylinder and that when closed prevents hydraulic fluid from moving from one of the first and second side of the hydraulic cylinder to the other of the first and second side of the hydraulic cylinder; wherein the pneumatic cylinder is actuated to open and close the door while the hydraulic cylinder dampens the movement of the pneumatic cylinder; wherein the hydraulic cylinder locks the door in an open position or in a closed position.

At least one embodiment of the invention provides a door actuation system for a vehicle comprising: a pneumatic cylinder connected by a valve to a source of on-board compressed air; a hydraulic cylinder having a hydraulic valve that when open allows hydraulic fluid to move from one of a first and second side of the hydraulic cylinder to the other of the first and second side of the hydraulic cylinder and that when closed prevents hydraulic fluid from moving from one of the first and second side of the hydraulic cylinder to the other of the first and second side of the hydraulic cylinder; wherein the pneumatic cylinder is actuated to open and close the door while the hydraulic cylinder dampens the movement of the pneumatic cylinder; wherein the hydraulic cylinder locks the door in an open position or in a closed position; a manual actuation system that simultaneously unlocks the hydraulic cylinder and actuates the pneumatic cylinder to open or close the door; and a high pressure emergency actuation system including a compressed air canister, a pressure regulator, and a valve.

### BRIEF DESCRIPTION OF THE DRAWINGS

Embodiments of this invention will now be described in further detail with reference to the accompanying drawing, in which:

FIG. 1 is a schematic view of an embodiment of the door opening system of the present invention;

FIG. 2 is a perspective view of an embodiment of the door opening system of the present invention;

FIG. 3 is a perspective view of another embodiment of the door opening system of the present invention;

FIG. 4 is a perspective view of the system of FIG. 3 mounted to a door in the door open position;

FIG. 5 is a cross-sectional view of the coaxial cylinder shown in FIG. 4 shown in a retracted position; and

FIG. 6 is a cross-sectional view of the coaxial cylinder shown in FIG. 4 shown in an extended position.

### DETAILED DESCRIPTION OF THE DRAWINGS

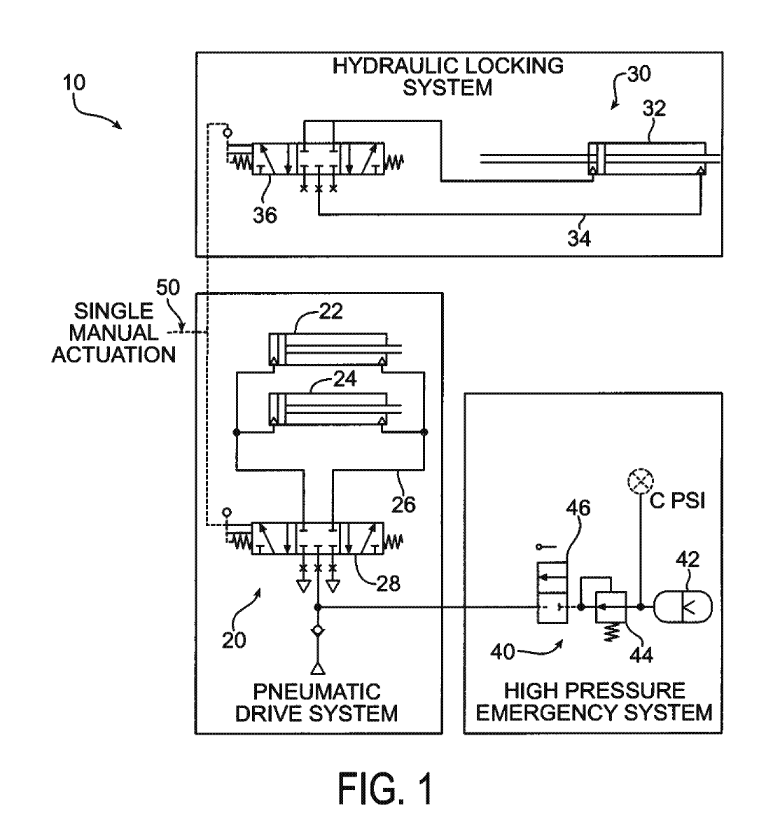

A schematic view of a door or hatch actuation system 10 is shown in FIG. 1. The system 10 comprises a pneumatic drive system 20 including at least one pneumatic cylinder 22, a hydraulic system 30, including a hydraulic cylinder 32. The system 10 may also include a high pressure emergency actuation system 40 discussed in more detail below.

The pneumatic drive system 20 shown has a first pneumatic cylinder 22 and a second pneumatic cylinder 24 positioned in parallel in a pneumatic circuit 26 and controlled by pneumatic valve 28. The hydraulic locking system 30 hydraulic cylinder 32 includes a hydraulic circuit 34 controlled by hydraulic valve 36. A manual actuation system 50 may be provided to simultaneously activate the hydraulic valve 36 to unlock the hydraulic cylinder 32 and activate the pneumatic valve 28 to actuate the pneumatic cylinders 22 to open or close the door.

The system may further comprise a high pressure emergency actuation system 40 including a compressed air canister 42, a pressure regulator 44, a ball valve 46, and a pneumatic circuit 48. This system 40 can provide compressed air to the pneumatic cylinders 22, 24 when on board air is unavailable.

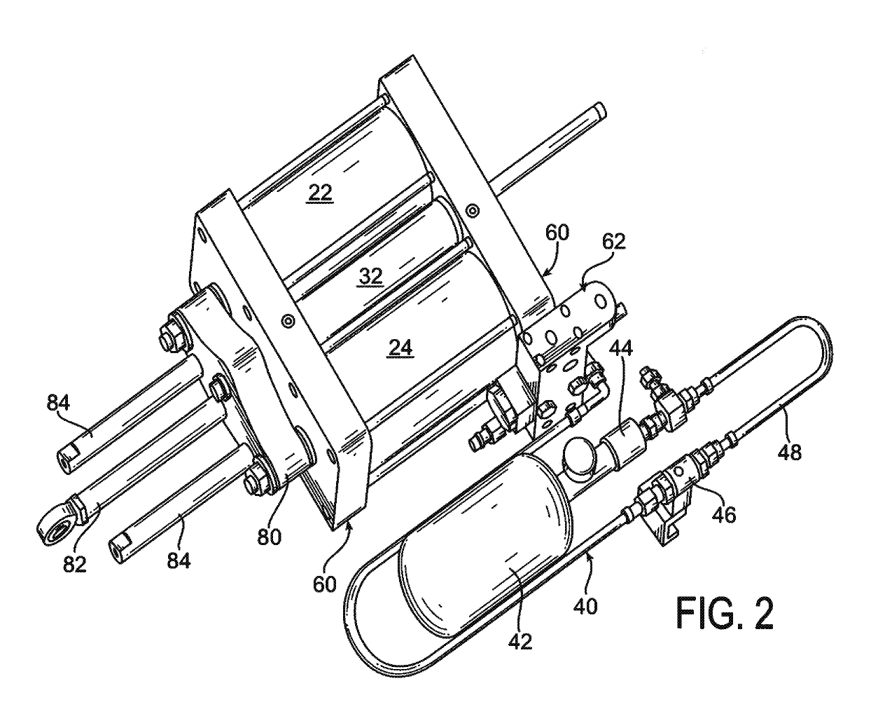

One embodiment of the door actuation system 10 is shown in FIG. 2. In this embodiment, the pneumatic cylinders 22, 24 and the hydraulic cylinder 32 are all shown mounted at least partially on a housing 60. The housing 60 is attachable to the door or hatch of a vehicle. The housing 60 is a single head and rod end cap set at either end of the cylinders that also acts as a manifold for a valve 62 to supply air to the pneumatic cylinders 22, 24 and hydraulic fluid to the hydraulic cylinder 32. The cylinders 22, 24, 32 each have a distal end of their rods (not shown) attached to a tool plate 80 having guide bars 84 and a fixed bar 82 extending therefrom, the end of the fixed bar 82 attachable to the linkage of a door or hatch. The pneumatic cylinders 22, 24 are connected to a source of onboard air while the hydraulic cylinder 32 has a fixed circuit of hydraulic fluid that is controlled by a hydraulic valve. The high pressure emergency actuation system 40 is also shown including compressed air canister 42, pressure regulator 44, ball valve 46, and pneumatic circuit 48.

In operation, the hydraulic valve 36 is opened to allow hydraulic fluid to flow from one side of the piston cylinder to the other as the pneumatic cylinders 22, 24 are actuated by compressed air from the source of onboard air by a pneumatic valve 26 to extend away from the housing 20, moving the tool plate 50 having fixed bar 52 to move the door linkage and the door to either an open or a closed position. The hydraulic cylinder 40 acts as a damper to reduce the speed of the pneumatic cylinder action. Once the door is in position, the hydraulic valve 44 is closed to prevent hydraulic fluid flow which acts to lock the hydraulic rod in position—which holds the door in an open or closed position.

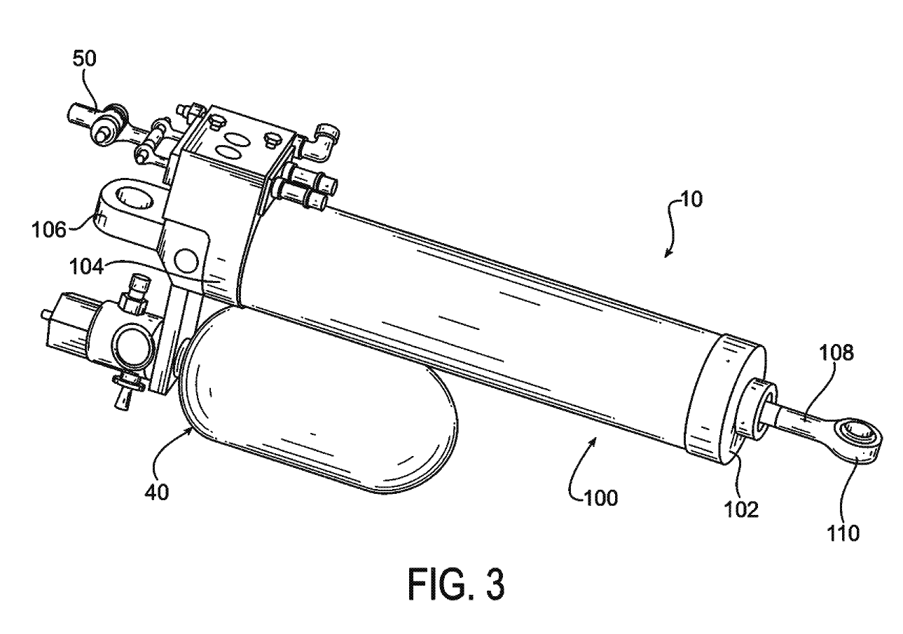

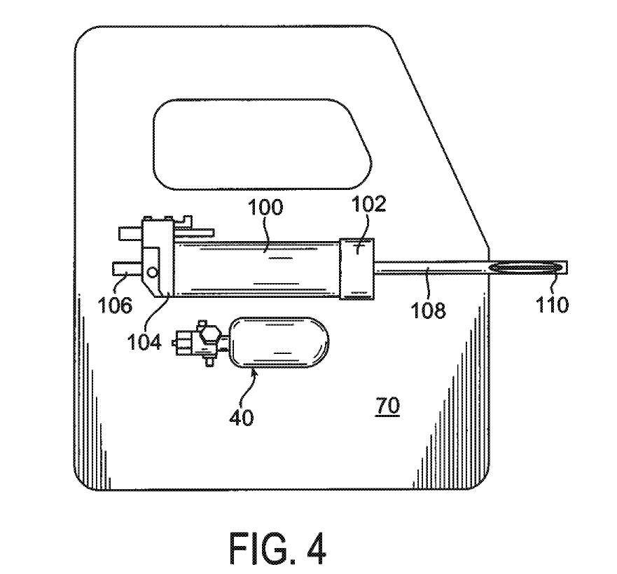

Another embodiment of the door assist system 10 is shown in FIGS. 3-6. In this embodiment, the pneumatic cylinders 22 are shown in tandem in a single cylinder housing 100. The housing 100 has a front head 102 and a rear head 104. The rear head 104 has a clevis 106 which attaches to the vehicle door. The rear head 104 also provides an attachment location for the hydraulic valve, pneumatic valve, as well as the emergency actuation system 40. The hydraulic cylinder 32 is coaxial with the pneumatic cylinders 22. A rod 108 extends from the front head side of the cylinder housing 100 shown with an articulated end or rod eye 110. The rod eye 110 attaches to a non-door portion of the vehicle such as the door frame. The system 10 utilizes two attachment points 106, 110 such that the system “floats” during actuation as opposed to being fixed to the door 70 as in the previous embodiment.

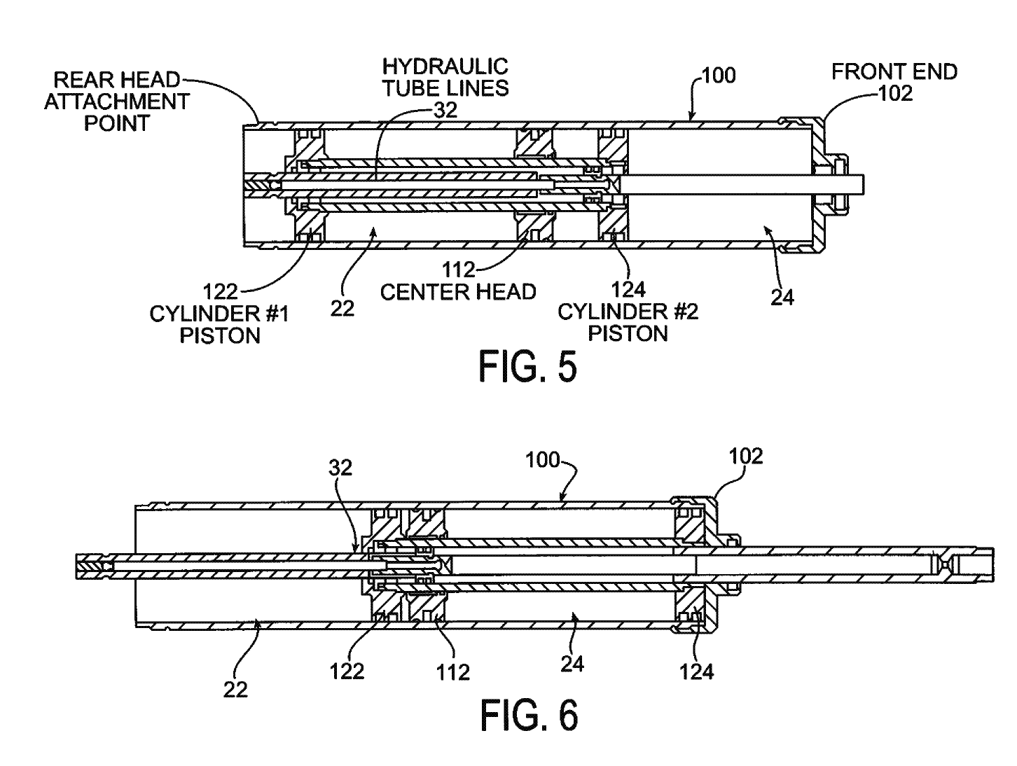

Additional details of the tandem pneumatic cylinders 22, 24 and coaxial hydraulic cylinder 32 is shown in cross-section in FIG. 5 showing a retracted position and FIG. 6 showing an extended position. The cylinder body 100 includes first cylinder piston 122 is positioned on a first side of cylinder head 112 and second cylinder piston 124 is positioned on a second side of cylinder head 112. The hydraulic cylinder 32 is formed coaxially and radially inward of the tandem pneumatic cylinders 22, 24.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention. Accordingly, the scope and content of the present invention are to be defined only by the terms of the appended claims.

What is claimed is:

1. A door actuation system for a vehicle comprising:
a pneumatic cylinder connected by a valve to a source of on-board compressed air;
a hydraulic cylinder having a hydraulic valve that when open allows hydraulic fluid to move from one of a first and second side of the hydraulic cylinder to the other of the first and second side of the hydraulic cylinder and that when closed prevents hydraulic fluid from moving from one of the first and second side of the hydraulic cylinder to the other of the first and second side of the hydraulic cylinder;
wherein the pneumatic cylinder is actuated to open and close the door while the hydraulic cylinder dampens the movement of the pneumatic cylinder;
wherein the hydraulic cylinder locks the door in an open position or in a closed position.

2. The system of claim 1 further comprising a high pressure emergency actuation system including a compressed air canister, a pressure regulator, and a valve.

3. The system of claim 1, further comprising a manual actuation system that simultaneously unlocks the hydraulic cylinder and actuates the pneumatic cylinder to open or close the door.

4. The system of claim 1 further comprising a second a pneumatic cylinder working with the first cylinder to open and close the door.

5. The system of claim 4 wherein the first and second pneumatic cylinders are positioned in parallel to each other to open and close the door.

6. The system of claim 5 wherein the first and second pneumatic cylinders are positioned in parallel to the hydraulic cylinder.

7. The system of claim 4 wherein the first and second pneumatic cylinders are positioned coaxial to each other to open and close the door.

8. The system of claim 1, wherein the hydraulic cylinder and the pneumatic cylinder are coaxial to each other.

9. The system of claim 7, wherein the hydraulic cylinder and the pneumatic cylinders are coaxial to each other.

10. The system of claim 2 wherein the emergency actuation system automatically overrides the hydraulic locking system.

11. The system of claim 1, wherein the hydraulic circuit fluid flow is restricted by an adjustable orifice.

12. The system of claim 3, wherein the system does not include any electrical power, controls, or sensors.

13. The system of claim 1 further comprising a housing attached to the door of a vehicle, the hydraulic cylinder and the pneumatic cylinder mounted on the housing.

14. The system of claim 9, the coaxial cylinders having a single rod extending from each end of the coaxial cylinders, a first end of the rod attached to a door of a vehicle and a second end of the rod attached to a non-door portion of the vehicle.

15. A door actuation system for a vehicle comprising:
a pneumatic cylinder connected by a valve to a source of on-board compressed air;
a hydraulic cylinder having a hydraulic valve that when open allows hydraulic fluid to move from one of a first and second side of the hydraulic cylinder to the other of the first and second side of the hydraulic cylinder and that when closed prevents hydraulic fluid from moving from one of the first and second side of the hydraulic cylinder to the other of the first and second side of the hydraulic cylinder;
wherein the pneumatic cylinder is actuated to open and close the door while the hydraulic cylinder dampens the movement of the pneumatic cylinder;
wherein the hydraulic cylinder locks the door in an open position or in a closed position;
a manual actuation system that simultaneously unlocks the hydraulic cylinder and actuates the pneumatic cylinder to open or close the door; and
a high pressure emergency actuation system including a compressed air canister, a pressure regulator, and a valve.

16. The system of claim 15 further comprising a second pneumatic cylinder positioned coaxial to the first pneumatic cylinder.

17. The system of claim 15, wherein the hydraulic cylinder and the pneumatic cylinder are coaxial to each other.

18. The system of claim 16, wherein the hydraulic cylinder and the pneumatic cylinders are coaxial to each other.

19. The system of claim 15, wherein the system does not include any electrical power, electronic controls, or sensors.

20. The system of claim 18, the coaxial cylinders having a single rod extending from each end of the coaxial cylinders, a first end of the rod attached to a door of a vehicle and a second end of the rod attached to a non-door portion of the vehicle.
